(19) United States
(12) Patent Application Publication
(10) Pub. No.: US 2024/0243491 A1
(43) Pub. Date: Jul. 18, 2024

(54) GROUND TAP CONNECTOR

(71) Applicant: Hubbell Incorporated, Shelton, CT (US)

(72) Inventor: Brian Royal Ellis, Dover, NH (US)

(21) Appl. No.: 18/410,292

(22) Filed: Jan. 11, 2024

Related U.S. Application Data
(60) Provisional application No. 63/438,593, filed on Jan. 12, 2023.

(51) Int. Cl. H01R 4/66; H01R 43/26

(52) U.S. Cl. CPC H01R 4/66; H01R 43/26

(57) ABSTRACT

A mechanical connector for securing an electrical conductor includes a rod and a pin. The rod includes a rod body, a first passage, and a second passage. The rod body has with a first rod end and a second rod end opposite to the first rod end. The first passage extends at least partially through the body. The second passage extends at least partially through the body and intersects with the first passage. The second passage receives the electrical conductor. The pin can be inserted through the first passage and toward the second passage. The pin includes a pin body with a first pin end and a second pin end opposite to the first pin end. The second pin end includes a blunt contact surface that can contact the electrical conductor within the second passage.

### CROSS-REFERENCE TO RELATED APPLICATION

This application claims the benefit of U.S. Provisional Application No. 63/438,593, filed Jan. 12, 2023, the entire contents of which is incorporated herein by reference in its entirety.

### FIELD

The present disclosure relates to a mechanical connector for an electrical conductor. More particularly, the present disclosure relates to a pin for applying pressure to an electrical conductor.

### BACKGROUND

Ground rods may be rigid metal members that are inserted into the earth. An electrical conductor is connected between the ground rod and an electrical device to electrically ground the electrical device. A press fit pin may be used to secure the electrical conductor to the ground rod. Pin designs currently in use are conical or triangular such that they narrow to a point or to a sharp edge. This design is chosen for manufacturability reasons. However, when the current pin is driven into a conductor, the point or sharp edge creates stress and can damage the conductor. For example, where a conductor is formed from multiple wires or strands, the point or sharp edge can split the different wires apart, thereby damaging the conductor and degrading the electrical connection provided by the conductor. Additionally, there may be significant shear stress at the point of contact because the area of the pin that contacts the conductor (e.g., a point) is very small. Conically shaped pins can thus decrease the electrical performance of the system.

### SUMMARY

Various examples of the present disclosure can overcome variations of the aforementioned and other disadvantages associated with known ground tap connectors and offer new advantages as well.

According to one aspect of various examples of the present disclosure there is provided a pin used in a ground tap connector having a frustoconical shape.

According to another aspect of various examples of the present disclosure, there is provided a pin used in a ground tap connector having a planar surface for contacting an electrical conductor.

According to another aspect of various examples of the present disclosure, there is provided a pin used in a ground tap connector having a stepped surface for contacting an electrical conductor.

According to another aspect of various examples of the present disclosure, there is provided a pin used in a ground tap connector having a conical or frustoconical surface forming a cavity.

According to another aspect of various examples of the present disclosure, there is provided a pin having a blunt surface for simultaneously contacting multiple strands of an electrical conductor.

According to another aspect of various examples of the present disclosure, there is provided a pin having a blunt surface for simultaneously contacting an electrical conductor with a single strand.

According to another aspect of various examples of the present disclosure, there is provided a pin having a blunt surface for simultaneously contacting multiple electrical conductors. The electrical conductors may have multiple strands and/or single strands.

Another aspect of various examples of the present disclosure includes a mechanical connector for securing an electrical conductor comprised of a rod and a pin. The rod includes a rod body, a first passage, and a second passage. The rod body has a first rod end and a second rod end opposite to the first rod end. The first passage extends at least partially through the body. The second passage extends at least partially through the body and intersects with the first passage. The second passage receives the electrical conductor. The pin can be inserted through the first passage and toward the second passage. The pin includes a pin body with a first pin end and a second pin end opposite to the first pin end. The second pin end includes a contact surface that is substantially flat and can contact the electrical conductor within the second passage.

Another aspect of various examples of the present disclosure includes a pin for use securing an electrical conductor within a passage. The pin includes a first end, a second end, and a central portion. The first end includes a first surface that receives an external force. The second end is disposed opposite to the first end. The second end includes a frustoconical shaped region and a second surface disposed at an end of the frustoconical shaped region. The central portion is disposed between the first end and the second end. The central portion has a greater width than either the first end or the second end. The second surface is positioned within the passage and contacts the electrical conductor.

Another aspect of various examples of the present disclosure includes a mechanical connector for securing an electrical conductor. The mechanical connector includes a rod that includes a rod body with a first rod end and a second rod end opposite to the first rod end. The rod also includes a first passage extending at least partially through the body, and a second passage extending at least partially through the body and intersecting with the first passage. The second passage includes an opening with a second passage width that is configured to receive the electrical conductor. The mechanical conductor also includes a pin that can be inserted through the first passage and toward the second passage. The pin includes a pin body with a first pin end and a second pin end opposite to the first pin end. The second pin end includes a blunt contact surface that can contact the electrical conductor within the second passage.

Another aspect of various examples of the present disclosure includes a mechanical connector for securing an electrical conductor. The mechanical connector includes a rod. The rod also includes a first passage extending at least partially through the body, and a second passage extending at least partially through the body and intersecting with the first passage. The second passage includes an opening with a second passage width that is configured to receive the electrical conductor. The mechanical conductor also includes a pin that can be inserted through the first passage and toward the second passage. The pin includes a pin body with a planar contact surface that can contact the electrical conductor within the second passage.

Another aspect of various examples of the present disclosure includes a pin for use securing an electrical conductor having multiple strands within a passage. The pin includes a first end including a first surface that can receive an external force, and a second end disposed opposite to the first end. The second end includes a frustoconical shaped region and a second surface disposed at an end of the frustoconical shaped region. The pin includes a central portion disposed between the first end and the second end. The central portion has a greater width than either the first end or the second end. The second end can be positioned within the passage and extend across at least two lengths of an associated electrical conductor.

Another aspect of various examples of the present disclosure includes a pin for use securing an electrical conductor having a single strand within a passage. The pin includes a first end including a first surface that can receive an external force, and a second end disposed opposite to the first end. The second end includes a frustoconical shaped region and a second surface disposed at an end of the frustoconical shaped region. The pin includes a central portion disposed between the first end and the second end. The central portion has a greater width than either the first end or the second end. The second end can be positioned within the passage and extend across at least two lengths of an associated electrical conductor.

Another aspect of various examples of the present disclosure includes a pin for use securing an electrical conductor having multiple strands within a passage. The pin includes a first end including a first surface that can receive an external force, and a second end disposed opposite to the first end. The second end includes a frustoconical shaped region and a second surface disposed at an end of the frustoconical shaped region. A projection extends from the frustoconically shaped region and the second surface is disposed at an end of the projection. The pin includes a central portion disposed between the first end and the second end. The second end can be positioned within the passage and extend across at least two lengths of an associated electrical conductor.

Another aspect of various examples of the present disclosure includes a pin for use securing an electrical conductor having a single strand within a passage. The pin includes a first end including a first surface that can receive an external force, and a second end disposed opposite to the first end. The second end includes a frustoconical shaped region and a second surface disposed at an end of the frustoconical shaped region. A projection extends from the frustoconically shaped region and the second surface is disposed at an end of the projection. The pin includes a central portion disposed between the first end and the second end. The second end can be positioned within the passage and extend across at least two lengths of an associated electrical conductor.

Another aspect of various examples of the present disclosure includes a pin for use securing an electrical conductor having multiple strands within a passage. The pin includes a first end including a first surface that can receive an external force, and a second end disposed opposite to the first end. The second end includes a frustoconical shaped region and a second surface disposed at an end of the frustoconical shaped region. The second end includes a cavity with a width that decreases in a direction toward the first end. An edge surrounds the second surface and can contact the at least two strands. The pin includes a central portion disposed between the first end and the second end. The second end can be positioned within the passage and extend across at least two lengths of an associated electrical conductor.

Another aspect of various examples of the present disclosure includes a pin for use securing an electrical conductor having a single strand within a passage. The pin includes a first end including a first surface that can receive an external force, and a second end disposed opposite to the first end. The second end includes a frustoconical shaped region and a second surface disposed at an end of the frustoconical shaped region. The second end includes a cavity with a width that decreases in a direction toward the first end. An edge surrounds the second surface and can contact the strand. The pin includes a central portion disposed between the first end and the second end. The second end can be positioned within the passage and extend across at least two lengths of an associated electrical conductor.

Another aspect of various examples of the present disclosure includes a rod for use containing and supporting electrical conductors. The rod includes a rod body extending along a rod axis between a first rod end and a second rod end opposite to the first rod end. The rod also includes a first passage, a second passage, and a third passage. The first passage extends at least partially through the body. The second passage extends entirely through the body and intersects with the first passage. The second passage includes an opening with an elongated shape that can receive the electrical conductors. The third passage extends at least partially through the body parallel to the first passage and spaced apart from the second passage.

Another aspect of various examples of the present disclosure includes a method for securing an electrical conductor that includes positioning a pin partially within a first passage of a rod; positioning an electrical conductor within a second passage of the rod, wherein the first passage and the second passage are substantially perpendicular to one another; applying a force to a first end of the pin at least partially exposed from the first passage; and moving a second end of the pin into contact with the electrical conductor, wherein the second end includes a planar contact surface configured to engage the electrical conductor.

Another aspect of various examples of the present disclosure includes a method for securing an electrical conductor that includes moving a second end of the pin into contact with the electrical conductor, wherein the second end includes a planar contact surface configured to engage the at least two lengths of the electrical conductor against a first plane parallel to the second passage; and compressing the electrical conductor against a surface of the second passage, wherein the planar contact surface is configured to engage the at least two strands of the electrical conductor against a second plane parallel to the first plane.

Another aspect of various examples of the present disclosure includes a method for securing an electrical conductor that includes moving a second end of the pin into contact with the electrical conductor, wherein the second end includes a planar contact surface configured to engage the at least two lengths of the electrical conductor against a first plane parallel to the second passage; and compressing the electrical conductor against a surface of the second passage, wherein the planar contact surface is configured to engage the strand of the electrical conductor against a second plane parallel to the first plane.

Another aspect of various examples of the present disclosure includes a method of securing an electrical conductor comprising selecting one of a first pin and a second pin, wherein each pin includes a planar contact surface; and moving the selected pin to engage the electrical conductor.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawings.

FIG. 1 is a front view of an assembled ground rod system.

FIG. 2 is an exploded view of the ground rod system of FIG. 1.

FIG. 3 is a cross-sectional view of a pin partially inserted into a rod of the ground rod system of FIG. 1.

FIG. 4 is a cross-sectional view of the rod of FIG. 3 without the pin.

FIG. 5 is a top perspective view of the pin capable of being inserted into the rod of FIG. 3.

FIG. 6 is a bottom perspective view of the pin of FIG. 5.

FIG. 7 is a front view of the pin of FIG. 5.

FIG. 8 is a bottom view of the pin of FIG. 5.

FIG. 9 is a cross-sectional exploded view of an alternate pin and the rod of the ground rod system of FIG. 1.

FIG. 10 is a top perspective view of the alternate example of the pin capable of being inserted into the rod of FIG. 3.

FIG. 11 is a bottom view of the pin of FIG. 10.

FIG. 12 is a front view of the pin of FIG. 10.

FIG. 13 is a cross-sectional exploded view of a further alternate pin and the rod of the ground rod system of FIG. 1.

FIG. 14 is a top perspective view of a further alternate example of a pin capable of being inserted into the rod of FIG. 3.

FIG. 15 is a bottom perspective view of the pin of FIG. 14.

FIG. 16 is a bottom view of the pin of FIG. 14.

FIG. 17 is a cross-sectional view of the pin of FIG. 14.

FIG. 18 is a first cross sectional view of an electrical conductor inserted into the rod and the pin partially inserted.

FIG. 19 is a second cross sectional view of an electrical conductor inserted into the rod and the pin partially inserted.

FIG. 20 is a cross sectional view of the electrical conductor inserted into the rod and the pin contacting the electrical conductor.

FIG. 21 is a perspective view of an assembled ground rod system according to another example.

FIG. 22 is an exploded view of the ground rod system of FIG. 21.

FIG. 23 is a perspective view of a rod used with the ground rod system of FIG. 21.

FIG. 24 is a cross-sectional view of the rod of FIG. 23 viewed along section 24-24.

FIG. 25 is a cross-sectional view a pin formed from the rod of FIG. 23, viewed along section 25-25.

FIG. 26 is a top perspective view of a pin used with the ground rod system of FIG. 21.

FIG. 27 is a bottom perspective view of the pin of FIG. 26.

FIG. 28 is a side view of the pin of FIG. 26.

FIG. 29 is a cross sectional view of an electrical conductor inserted into the rod and the pin partially inserted.

FIG. 30 is a cross sectional view of the electrical conductor inserted into the rod and the pin contacting the electrical conductor.

### DETAILED DESCRIPTION

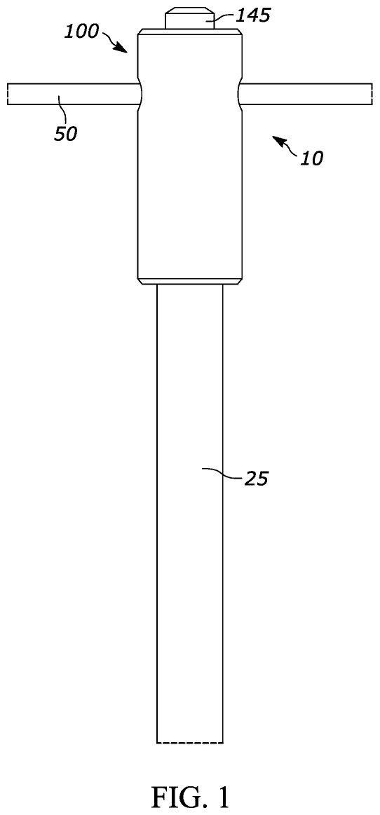

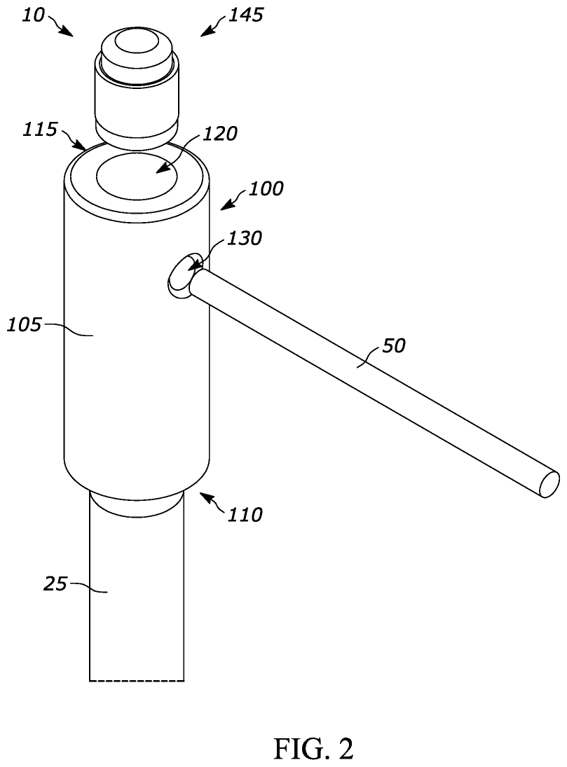

FIGS. 1 and 2 illustrate a ground rod system 10 that includes a ground rod 25 that may be inserted into the earth to ground various electrical applications. The ground rod 25 may be a substantially cylindrical member, although other shapes may be used (e.g., conical, frustoconical, rectangular, etc.). In other examples, the ground rod 25 may include a conical portion (e.g., a point) at one or more ends to facilitate insertion into the ground. The ground rod 25 may be constructed from a metallic material, although other materials may also be used.

The ground rod system 10 also includes an electrical conductor 50 (e.g., a wire), rod 100, and a pin 145. As described in more detail below, the rod 100 may be directly connected to the ground rod 25 (e.g., using a press fit or friction fit), and the electrical conductor 50 and pin 145 may be connected to the rod 100.

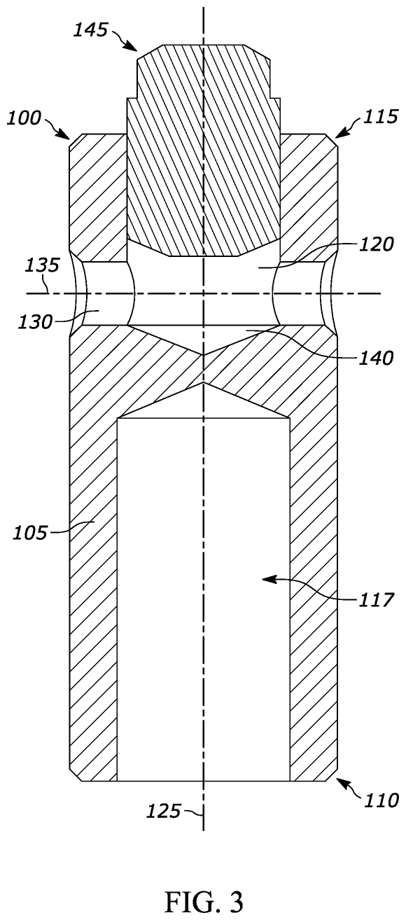

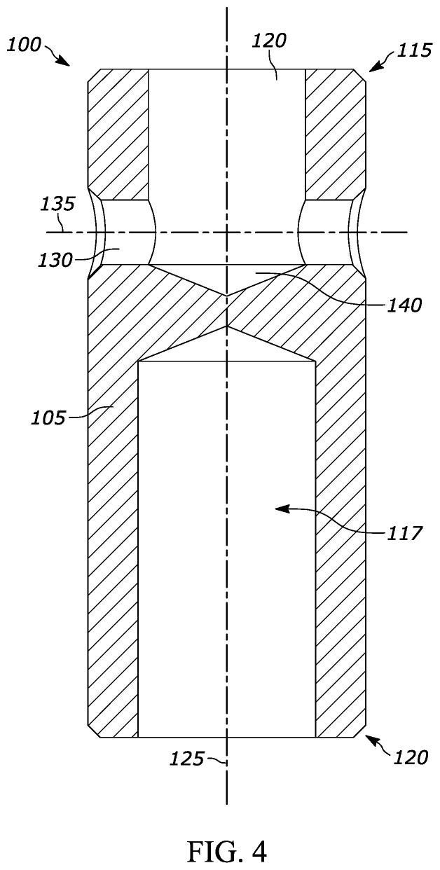

As shown in FIGS. 3 and 4, the rod 100 includes an elongated body 105 with a first end 110 and a second end 115 that is opposite to the first end 110. In the illustrated example, the first end 110 may be considered a bottom of the rod 100 and the second end 115 may be considered a top of the rod 100.

The rod 100 may be a sleeve for connecting to the ground rod 25 that is inserted into the earth. This way, the rod 100 itself may not be directly inserted into the earth. The first end 110 of the rod 100 may include a passageway 117 that can receive the ground rod (e.g., using a friction fit or press fit). In alternative examples, the rod 100 may be a ground rod and the first end 110 may be inserted directly into the earth. In this example, the first end 110 may or may not include the passageway 117.

The second end 115 of the rod 100 includes a first passage 120, which may have a substantially cylindrical opening. The first passage 120 may extend substantially along a first axis 125 of the elongated body 105 that extends between the first and second ends 110, 115.

In some forms, the first passage 120 may have a substantially uniform width along the first axis 125. Although the first passage 120 may have varying widths in other examples.

In the illustrated example, the passageway 117 may also extend along the first axis 125. For example, the passageway 117 and the first passage 120 may be concentric, although one may be offset from the other. The passageway 117 is also illustrated as having a larger diameter than the first passage 120, although the first passage 120 may have a diameter that is greater than or equal to the diameter of the passageway 117.

The elongated body 105 may also include a second passage 130 that intersects with the first passage 120. For example, the second passage 130 may extend along a second axis 135 that intersects with the first axis 125. The first passage 120 may terminate within the second passage 130. The first passage 120 and the second passage 130 may be perpendicular to one another (e.g., the first and second axes 125, 135 are substantially perpendicular to one another), although other orientations may be used.

In the illustrated example, the second passage 130 may have a wider diameter at either end and at least slightly narrower diameter toward a center. For example, the second passage 130 may have a constant but narrower diameter moving toward the intersection with the first axis 125. The second passage 130 may increase in width as it intersects with the outer width of the first passage 120 (e.g., before reaching the first axis 125). This width may be larger than the width at either end of the second passage 130.

The rod 100 may also include a depressed region 140 within the second passage 130 that is at least partially aligned with the first axis 125 (e.g., a center of the depressed region 140 may be aligned with the first axis 125). In the illustrated example, the depressed region 140 may be conical in shape with a substantially triangular cross-section, although other shapes may be used (e.g., frustoconical, spherical, elliptical cylindrical, rectangular, etc.).

With continuing reference to FIG. 3, a pin 145 may be inserted into the first passage 120. The pin 145 may be designed to alleviate problems associated with the conical pin because the pin 145 may reduce occurrences of electrical conductor damage. Specifically, the pin 145 described below may be able to contact a multi-strand electrical conductor without causing the individual conductors to split apart. However, the pin 145 may also be used with a single-strand electrical connector without departing from the scope of the disclosure.

The pin 145 may accomplish this by providing a contact surface capable of contacting an electrical conductor 50 that has a larger surface area than that of the pin currently in use (e.g., with the conical or thin edge). As described below, a larger surface area may more evenly distribute forces across the electrical conductor 50 so that the force can be applied to multiple strands within the electrical conductor 50. This is accomplished when the pin is in contact (either directly or indirectly through an insulative material) with multiple strands of the electrical conductor.

The pin 145 may have an at least partially cylindrical shape so that the shape of the pin 145 corresponds to the shape of the first passage 120. For example, an outer diameter of the pin 145 may be substantially similar to an inner diameter of the first passage 120. The pin 145 may fit snuggly within the first passage 120 (e.g., so that there is little to no gap between the pin 145 and the wall of the first passage 120).

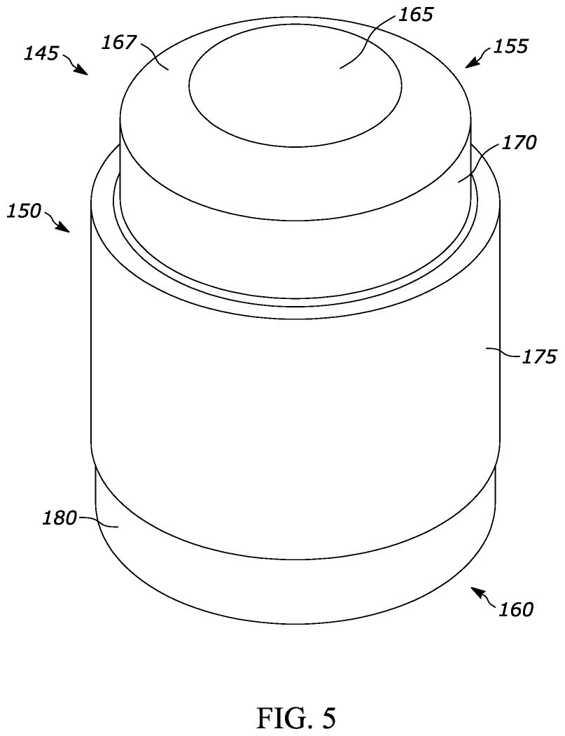

As shown in FIGS. 5 to 8, the pin 145 includes a body 150 having a first end 155 and a second end 160 that is opposite to the first end 155. As described above, the body 150 may have a partially cylindrical shape, although the body 150 may not be a cylinder.

In the illustrated example, the first end 155 of the body 150 includes a substantially flat surface 165. The flat surface 165 includes a circular shape, although other shapes (e.g., elliptical, triangular, rectangular, etc.) may also be used. Additionally, other examples may include a raised surface, which may be formed as a step, a curve, and/or an incline. In certain examples, the surface 165 can be textured, for example having ridges, knurls, or other rough surface textures. The first end 155 may increase in width from the flat surface 165 along an inclined surface 167 and may extend to a substantially cylindrical surface 170. The outer diameter of the cylindrical surface 170 of the first end 155 may be wider than the diameter of the flat surface 165.

A central portion 175 of the body 150 is disposed between the first end 155 and the second end 160. The central portion 175 may be wider than the first end 155. In other words, an outer diameter of the central portion 175 may be wider than the outer diameter of the cylindrical surface 170. The central portion 175 may be substantially cylindrical in shape.

In the illustrated example, the transition between the first end 155 and the central portion 175 may be stepped. In other examples (not shown), the transition may be inclined or curved.

With continued reference to FIGS. 5 to 8, the second end 160 of the body 150 may include a similar shape to the first end 155. For example, the second end 160 may include a cylindrical surface 180 proximate to the central portion 175. An inclined surface 183 of the second end 160 extends from the cylindrical surface 180 in a direction away from the central portion 175. A contact surface 185 is disposed at a center of the inclined surface 183.

In the illustrated example, an outer diameter of the cylindrical surface 180 of the second end 160 is smaller than the outer diameter of the central portion 175. The transition between the second end 160 and the central portion 175 may be stepped. In other examples (not shown), the transition may be inclined or curved. In still other examples, there may be no transition between the second end 160 and the central portion 175 (e.g., the second end 160 and the central portion 175 have the same maximum width).

In some forms, the step between the central portion 175 and the second end 160 may be smaller than the step between the central portion 175 and the first end 155. In other words, the outer diameter of the cylindrical surface 180 at the second end 160 may be larger than the outer diameter of the cylindrical surface 170 at the first end 155. The width of the step at the second end 160 is therefore smaller in the radial direction as compared to the width of the step at the first end 155.

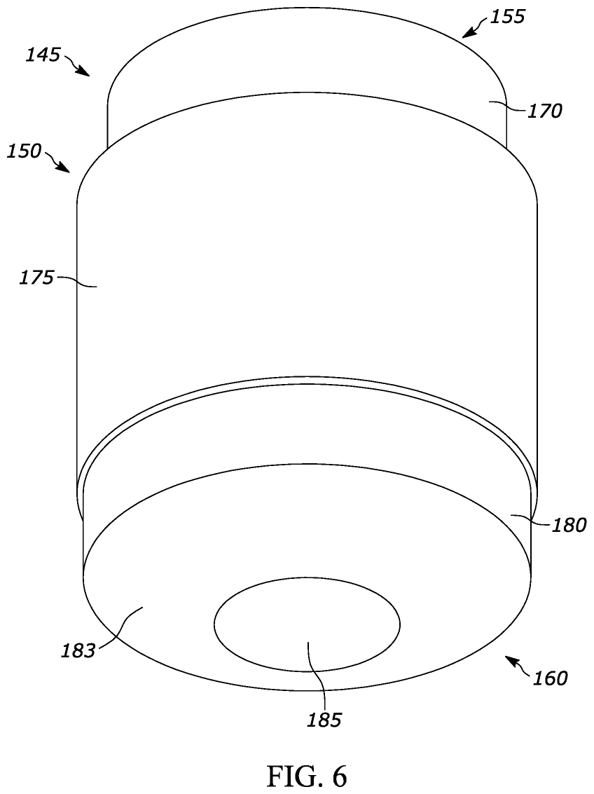

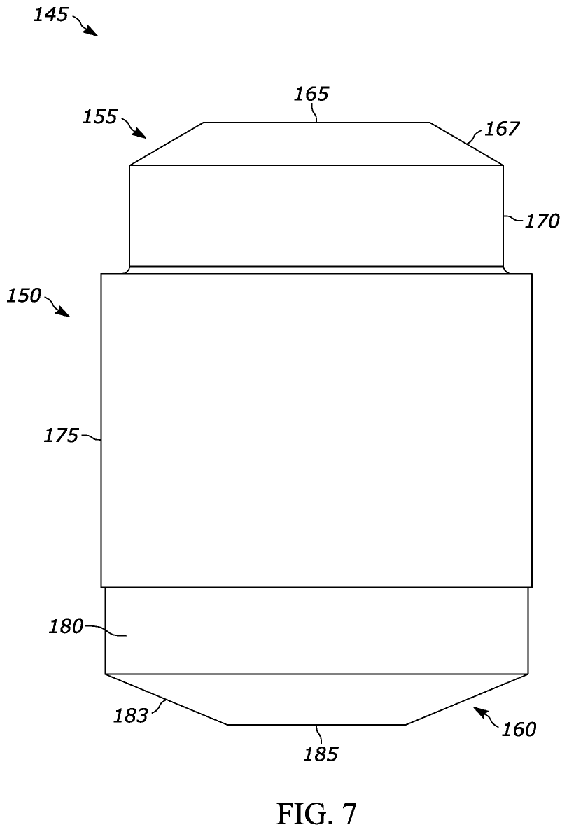

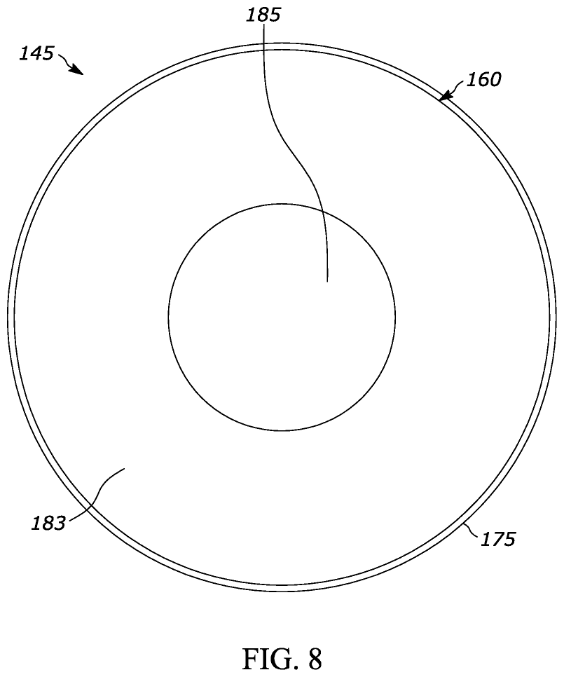

As shown in FIGS. 6 and 8, the contact surface 185 of the second end 160 may be substantially circular in shape, although other shapes may be used (e.g., elliptical, triangular, rectangular, etc.). The contact surface 185 may have a smaller diameter than the flat surface 165 (see e.g., FIG. 7), however, other examples may include a contact surface 185 that is equal to or larger than the flat surface 165. The inclined surface 183 of the second end 160 may be larger than the inclined surface 167 of the first end 155.

In some forms, the surface area of the contact surface 185 may be at least about 10% of the surface area of the flat surface 165. In some forms, the surface area of the contact surface 185 may be at least about 25% of the surface area of the flat surface 165. In some forms, the surface area of the contact surface 185 may be at least about 50% of the surface area of the flat surface 165. In some forms, the surface area of the contact surface 185 may be at least about 60% of the surface area of the flat surface 165. In some forms, the surface area of the contact surface 185 may be at least about 75% of the surface area of the flat surface 165. In some forms, the surface area of the contact surface 185 may be at least about 100% of the surface area of the flat surface 165.

Just as the flat surface 165 provides a sufficient contact area in order to facilitate providing a force to move the pin within the first passage 120, the contact surface 185 similarly provides a sufficient contact area to contact across the electrical conductor 50. The surface area of the contact surface 185 may be smaller in order to avoid contact with the wall of the first passage 120 but may otherwise be similar in shape and/or size to the flat surface 165.

As shown in FIG. 7, the contact surface 185 may be a blunt surface, which may be substantially flat or planar. For example, the contact surface 185 and the flat surface 165 may be parallel to one another. Additionally, the plane of the contact surface 185 may intersect an edge of the inclined surface 183 of the second end 160. In certain examples, the surface 165 can be textured, for example having ridges, knurls, or other rough surface textures.

In some forms, the contact surface 185 may have a width (e.g., a diameter) that is larger than the diameter of an electrical conductor 50. When centered with the electrical conductor 50, the larger width of the contact surface 185 may allow the pin 145 to contact and compress substantially all the electrical conductor 50.

This improves on a pin with the conical shape that narrows to a point because the contact area of the contact surface 185 is larger. This larger surface area distributes the stresses over a larger area along the electrical conductor so that more of the strands experience the force and high concentrations of stress between strands is reduced or eliminated.

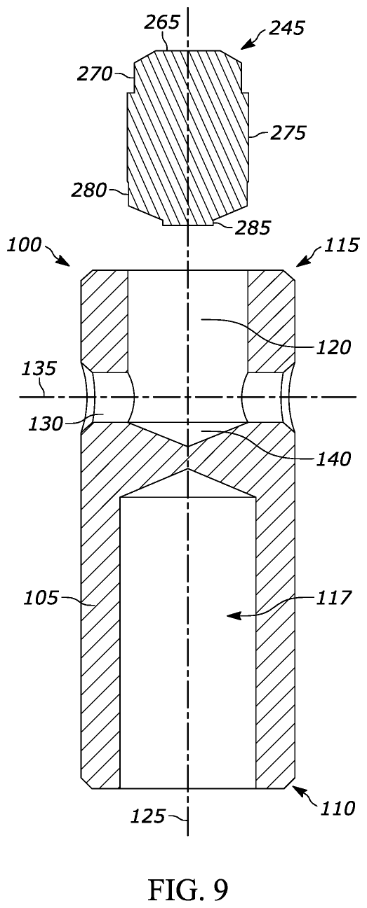

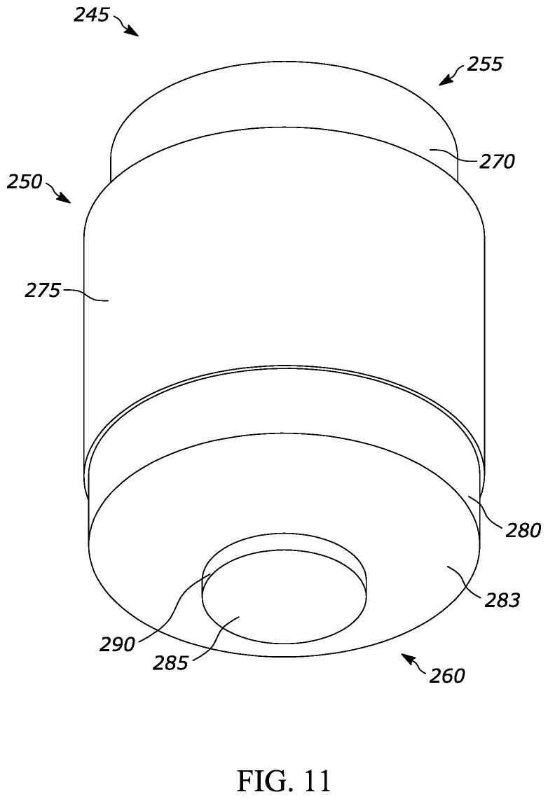

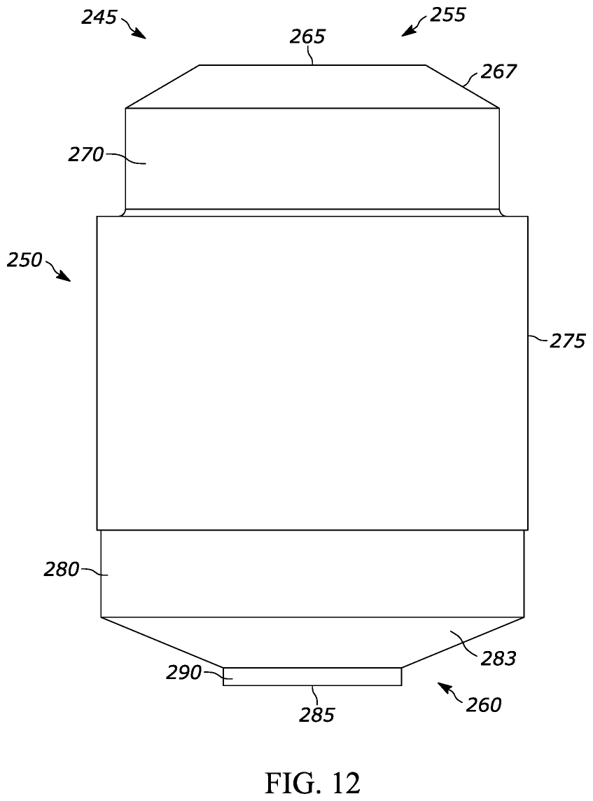

FIGS. 9 to 12 illustrate a pin 245 that is substantially similar to pin 145. Similar elements are labeled with the same reference number plus “100”. Only some similarities and differences between the pin 145 and the pin 245 are described.

The pin 245 includes a first end 255, a second end 260, and a central portion 275. The shapes of the first end 255, the second end 260, and the central portion 275 are substantially similar to the shapes of the respective first end 155, second end 160, and central portion 175.

As shown in FIGS. 9 to 12, the contact surface 285 is formed at an end of a protruding section 290. In other words, a plane of the contact surface 285 may be parallel to a plane of the flat surface 265. However, the plane of the contact surface 285 may not intersect an edge of the inclined section 283 of the second end 260. The illustrated protruding section 290 may be cylindrical in shape, although other shapes (e.g., frustoconical) may be used. In certain examples, the surface 165 can be textured, for example having ridges, knurls, or other rough surface textures.

Similar to the contact surface 185 and the flat surface 165, the contact surface 285 and the flat surface 265 may be similar in size. For example, the flat surface 265 may be larger than the contact surface 285 but both may have a similar width.

The illustrated contact surface 285 may be circular in shape and may be similarly shaped to the flat surface 265. However, in other examples, the contact surface 285 may have a different shape (e.g., triangular, rectangular, etc.).

In some forms, the surface area of the contact surface 285 may be at least about 10% of the surface area of the flat surface 265. In some forms, the surface area of the contact surface 285 may be at least about 25% of the surface area of the flat surface 265. In some forms, the surface area of the contact surface 285 may be at least about 50% of the surface area of the flat surface 265. In some forms, the surface area of the contact surface 285 may be at least about 60% of the surface area of the flat surface 265. In some forms, the surface area of the contact surface 285 may be at least about 75% of the surface area of the flat surface 265. In some forms, the surface area of the contact surface 285 may be at least about 100% of the surface area of the flat surface 265.

In some forms, the pin 245 may be used in multi-conductor applications and/or with larger diameter conductors. As described below, the protruding section 290 may assist in positioning the conductors 290 and/or may apply a more concentrated and greater securing force, which larger conductors can handle without becoming damaged.

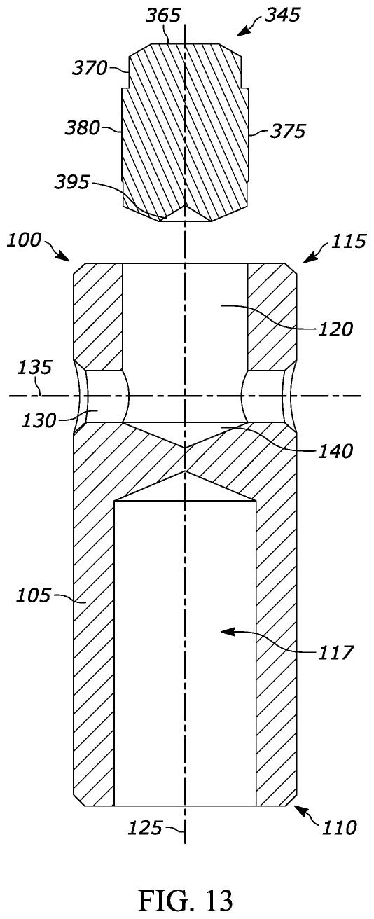

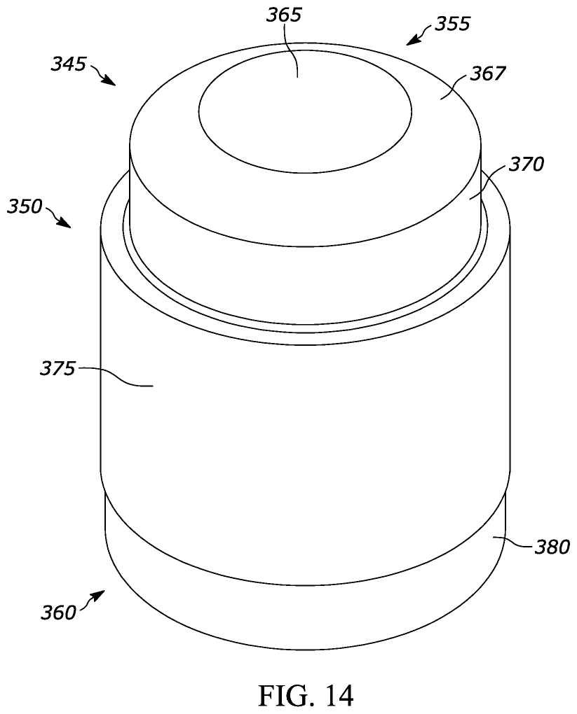

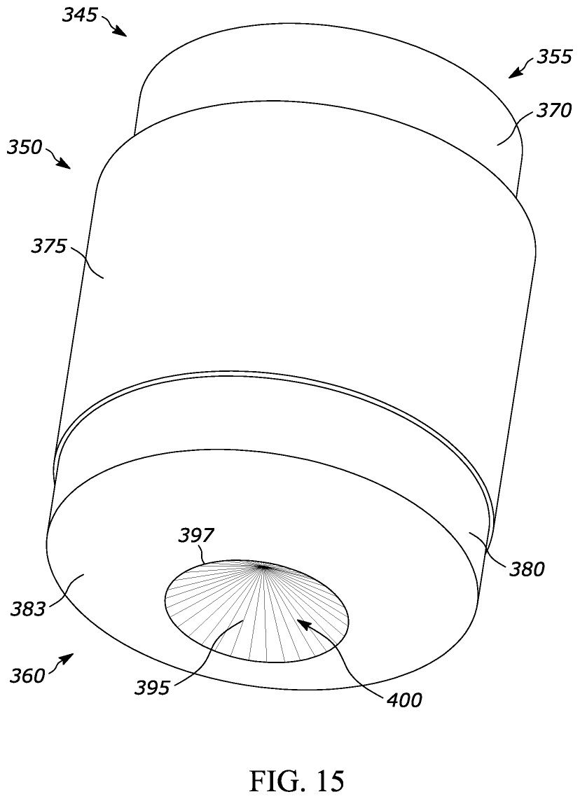

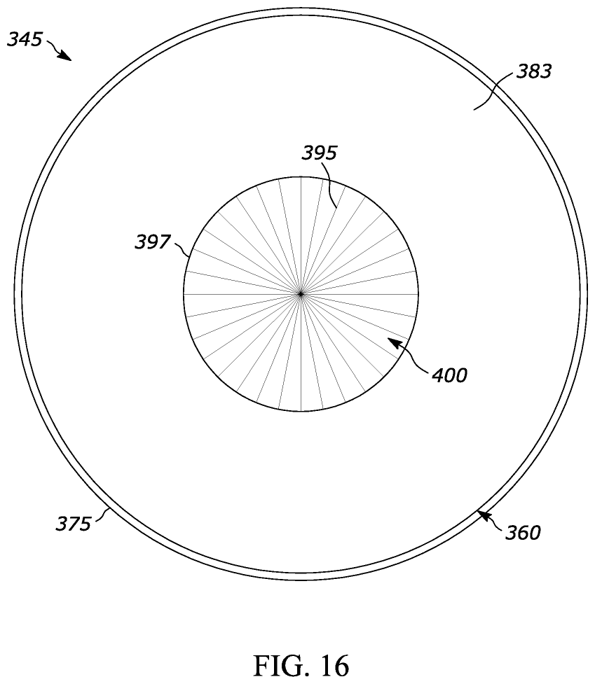

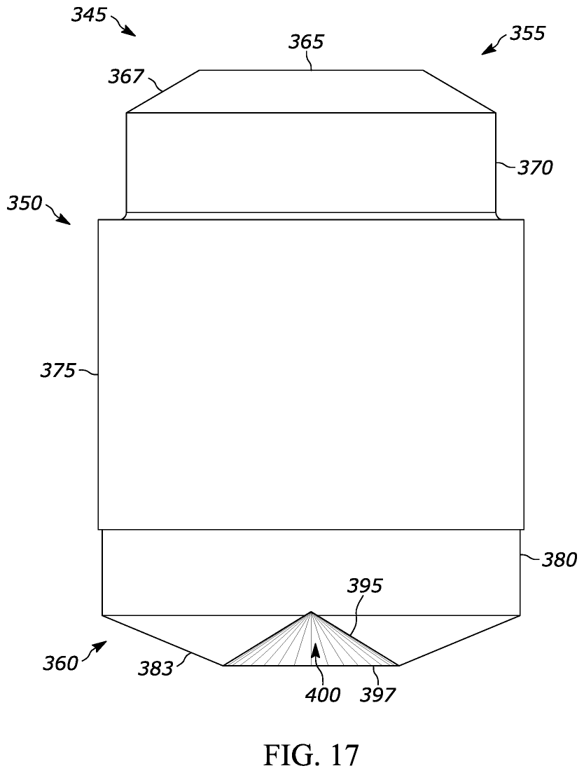

FIGS. 13 to 17 illustrate a pin 345 that is substantially similar to pin 145. Similar elements are labeled with the same reference number plus “200”. Only some similarities and differences between the pin 145 and the pin 345 are described.

The pin 345 includes a first end 355, a second end 360, and a central portion 375. The shapes of the first end 355, the second end 360, and the central portion 375 are substantially similar to the shapes of the respective first end 155, second end 160, and central portion 175.

As shown in FIGS. 13 to 17, the second end 360 may not include a planar contact surface. Instead, the second end 360 includes one or more walls 395 forming a cavity 400. The outer width of the walls 395 may have substantially the same width as the contact surface 185. Additionally, an opening to the cavity 400 may be on a plane that intersects with the edges 397 (or a single edge 397) of the inclined surface 383 of the second end 360. However, in other examples, the opening to the cavity 400 may be spaced apart from a surface containing the edges 397 of the inclined surface 383 (e.g., like the protruding section 290 in FIGS. 9 to 12).

In the illustrated example, the second end 360 includes a single wall 395 that is formed in a conical shape. In other words, the wall 395 may be curved and taper to a point in a direction toward the first end 355 along the first axis 325. However, in other examples, there may be multiple walls 395 and/or the one or more walls 395 may be formed in a different shape (e.g., frustoconical, cylindrical, etc.).

In some forms, the wall 395 may not be a contact surface and only an outer perimeter of the opening to the cavity 400 may be a contact region. In other words, an edge forming an ingress to the cavity 400 may be considered the contact region.

In some forms, the cavity 400 may be machined to remove any projections or protrusions that remain because of manufacturing the pin 345. For example, the cavity 400 may eliminate an end point that would otherwise occur during manufacturing, which would act similarly to the conical shaped pin (e.g., hurting electrical connection).

The edges 397 may act as a contact region for the pin 345. The contact area may be less than the contact area of the pin 145 (e.g., the surface area of the contact surface 185) or the pin 245 (e.g., the surface area of the contact surface 285). However, the total length of the edges 397 may be greater than the length of the edge or point on the conical pin. In this way, there is a greater contact perimeter against the electrical conductor 50 when the pin 345 is used as compared to the conical conductor. Further arranging the contact edges 397 as a closed (or substantially closed) perimeter distributes the forces applied by the pin 345 across a wider area than with the conical pin, further reducing localized stresses than can cause the strands in the electrical conductor 50 to split. For example, the contact surface area of the contact edges 397 may be greater than that of the conical pin and may be more widely dispersed, which distributes forces across an area instead of concentrated at a single point.

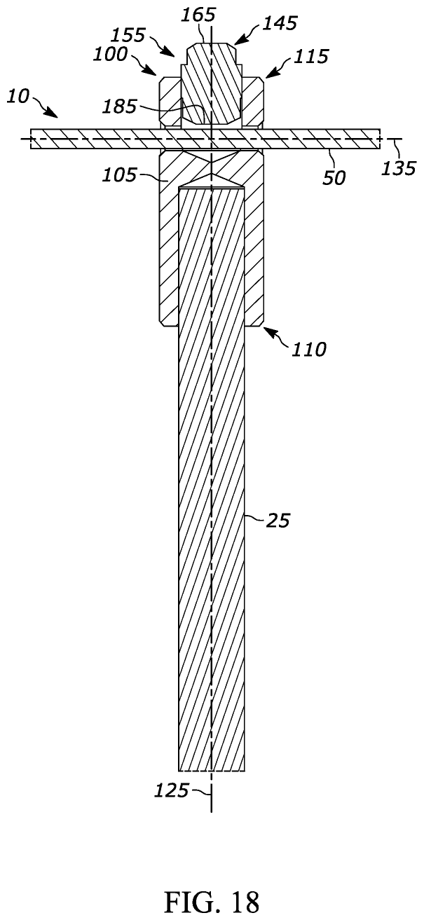

In use, an electrical conductor 50 may be inserted into the second passage 130 along the second axis 135 (see e.g., FIG. 18). The width of the second passage 130 may be similar to the width of the electrical conductor 50 so that the electrical conductor 50 is able to move along the second passage 130 without moving substantially in the direction of the first axis 125. The entrance to the second passage 130 may be slightly wider to facilitate easier insertion. In some examples, the electrical conductor 50 may pass entirely through the second passage 130.

Any one of the pins 145, 245, 345 may be inserted along the first axis 125 through the first passage 120. For simplicity, reference to the pin 145 may be equally applicable to the pins 245, 345 except where indicated otherwise.

The second end 160 of the pin 145 may be inserted into the first passage 120 so that the first end 155 remains outside of the first passage 120. As described above, the shape of the central portion 170 may be substantially similar to the shape of the first passage 120. Thus, the pin 145 may not be able to substantially move along the direction of the second axis 135.

In some forms, the pin 145 and the rod 100 may be partially assembled prior to use (e.g., partially assembled when shipped to the user). The pin 145 may be positioned so that the cylindrical surface 180 is positioned within the first passage 120. Because the cylindrical surface 180 has an outer diameter that is less than the diameter of the first passage 120, the pin may not be pre-secured to the rod 100. Thus, the smaller diameter of the cylindrical surface 180 assists in guiding the pin 145 into the first passage 120 without pre-securing the pin 145.

In some forms, the width of the first passage 120 may not allow the pin 145 to freely slide along the first axis 125. An outside force may be applied in order to move the pin 145 along the first axis 125. For example, a hammer or other tool may be used to apply a force to the flat surface 165 to move the pin 145. The flat surface 165 provides an even surface to apply a force in order to limit the travel of the pin 145 in a direction other than along the first axis 125.

In some forms, the increased width of the central portion 175 compared to the first end 155 may provide a visual indicator for the user. For example, the first end 155 may remain substantially outside of the first passage 120 to avoid over-compressing the conductor. The difference in width may alert the user before the pin 145 over-travels within the first passage 120.

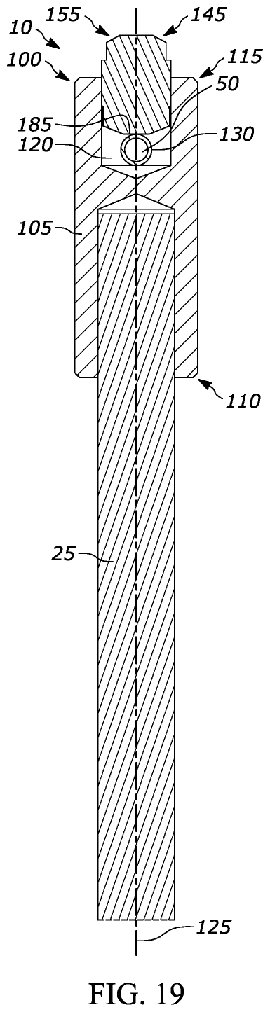

As shown in FIG. 19, the contact surface 185 may have a width that is approximately equal to the second passage 130. The width of the electrical conductor 50 may not exceed the width of the second passage 130, so the width of the contact surface 185 may always be equal to or greater than the width of the electrical conductor 50. This may limit instances where the contact surface 185 applies a force onto the electrical conductor 50 in a small area where strand splitting could occur. In other examples, the width of the contact surface 185 may be less than the width of the second passage 130. In these situations, the contact surface 185 may remain sufficiently large in order to contact multiple strands of the electrical conductor 50 (or an electrical conductor 50 with single a stand).

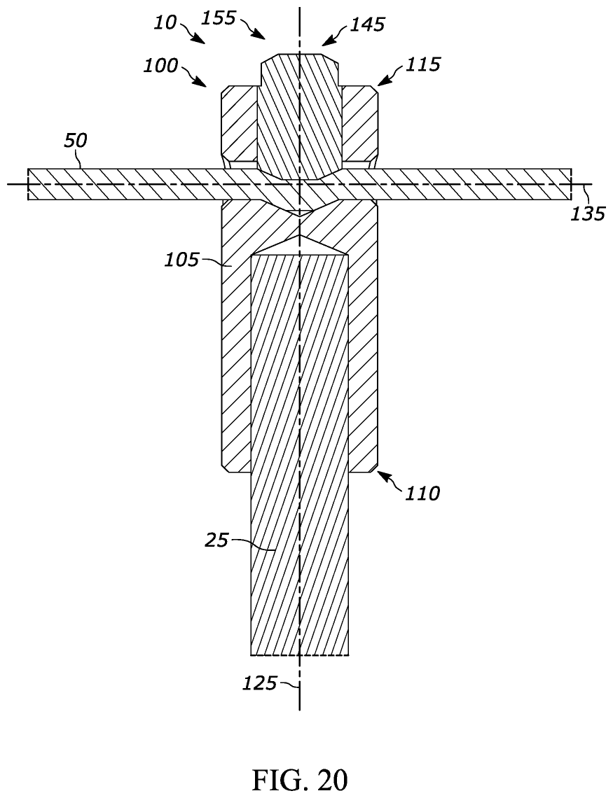

As shown in FIG. 20, the pin 145 eventually contacts the electrical conductor 50 as the pin 145 moves along the first axis 125 (e.g., because of a force applied to the flat surface 165). Specifically, the contact surface 185 meets the electrical conductor 50 proximate to an entrance of the second passage 130 from the first passage 120. The substantially flat surface of the contact surface 185 may provide a substantially even surface for contacting the electrical conductor 50. This contact may be along the first axis 125 (e.g., in an inferior direction as viewed in FIG. 18) against a perpendicular plane that is tangent to or coplanar with a surface of the electrical conductor 50. This plane may intersect the electrical conductor so that it intersects with multiple strands of the electrical conductor 50 or is parallel to a plane that intersects multiple strands of the electrical conductor 50. As additional force is provided to the pin 145, the contact surface 185 may begin to compress the electrical conductor 50. The compression may be distributed across the surface of the electrical conductor 50 in contact with the contact surface 185. As shown between FIGS. 18 to 20, continued force applied to the pin 145 may move the plane where contact (and therefore compression) occurs toward the first end 110. This plane may remain substantially parallel to the second axis 135.

This compression between the pin 145 and the surface of the second passage 130 may limit movement of the electrical conductor 50 with respect to the second passage 130. Additionally, the electrical conductor 50 may compress into the depressed region 140, which may further limit movement of the electrical conductor 50 along the second passage 130.

The contact surface 185 may provide an advantage over a contact point because it provides a greater contact area between the pin 145 and the electrical conductor 50. For example, the contact surface 185 can contact multiple strands of a single electrical conductor 50 and/or may contact multiple electrical conductors 50 against the perpendicular plane (which may also be parallel to the second axis 135). This also spreads the force over a greater area of the electrical conductor 50 (or electrical conductors 50). The contract surface 185 therefore may limit damage to the electrical conductor 50 (e.g., splitting wires of the cable) caused from applying pressure with the pin 145.

With continued reference to FIG. 20, the electrical conductor 50 may deform slightly into the depressed region 140 as the second end 160 of the pin 145 engages the electrical conductor 50.

When the pin 245 is used, the contact surface 285 protrudes from the remainder of the second end 260 via the protruding section 290. The protruding section 290 may direct the force applied to the flat surface 265 toward the contact surface 285 and limit force from being applied to other regions of the second end 260 (e.g., in the inclined surface 283). This may provide additional pressure (e.g., as compared to the flush example of FIGS. 5 to 8) spread out over a larger area (e.g., as compared to a spike or conical pin).

When multiple conductors are inserted through the second passage 130, the contact surface 285 may act as a wedge or guide for positioning and securing the conductors. For example, the contact surface 285 may assist in positioning the conductors between the wall of the first passage 120 and the inclined section 283 of the pin 245. This may assist in limiting unwanted interactions between the conductors during operation. Once the conductors are positioned and the pin 245 is inserted, the protruding contact surface 285 may cause the conductors or bow out and be better secured within the rod 100.

When the pin 345 is used, only the edge forming the opening of the cavity 400 may directly contact the electrical conductor 50. This may provide a greater dispersion of the force than in an example where the second end 360 extends to a point. The wall 395 not contacting the electrical conductor 50 may result in less of the electrical conductor 50 being compressed.

In some forms, the pin 345 may be used with a thicker, single-strand conductor or with a flex conductor, neither of which may significantly degrade as a result of contact with the pin 345.

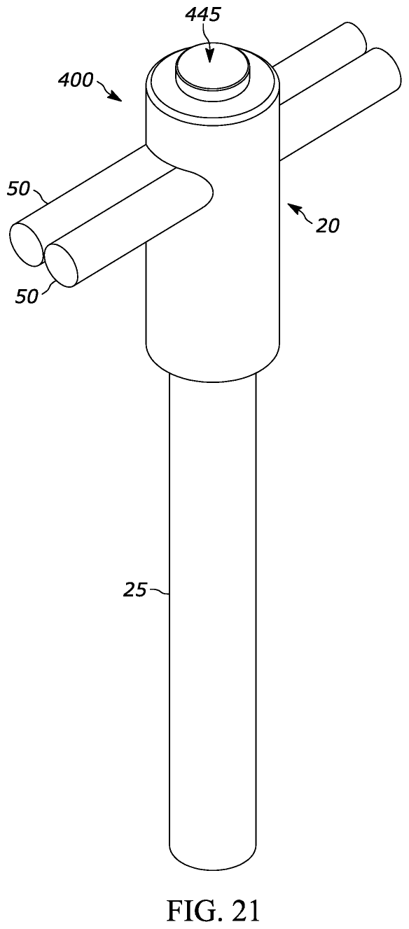

FIGS. 21 to 30 illustrate another example of a ground rod system which is intended to house multiple electrical conductors 50 (e.g., two shown, although the ground rod system may be modified to include any number). The elements of the ground rod system 20 illustrated in FIGS. 21 to 30 may be similar to the ground rod system 10 illustrated in FIGS. 1 to 20 and only some similarities and differences may be disclosed. Similar features may include the same reference number plus “300”.

The ground rod system 20 includes multiple electrical conductors 50 (e.g., two wires, although any number), rod 400, and a pin 445. As described in more detail below, the rod 400 may be directly connected to the ground rod 25 (e.g., using a press fit or friction fit), and the electrical conductor 50 and pin 445 may be connected to the rod 400.

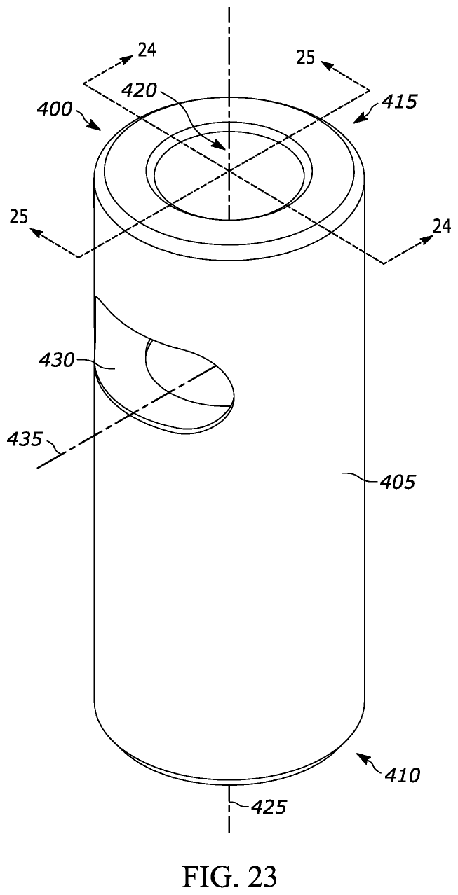

As shown in FIG. 23, the rod 400 includes an elongated body 405 with a first end 410 and a second end 415 that is opposite to the first end 410. In the illustrated example, the first end 410 may be considered a bottom of the rod 400 and the second end 415 may be considered a top of the rod 400.

The second end 415 of the rod 400 includes a first passage 420, which may have a substantially cylindrical opening. The first passage 420 may extend substantially along a first axis 425 of the elongated body 405 that extends between the first and second ends 410, 415.

In some forms, the first passage 420 may have a substantially uniform width along the first axis 425. Although the first passage 420 may have varying widths in other examples.

In the illustrated example, the passageway 417 may also extend along the first axis 425. For example, the passageway 417 and the first passage 420 may be concentric, although one may be offset from the other. The passageway 417 is also illustrated as having a larger diameter than the first passage 420, although the first passage 420 may have a diameter that is greater than or equal to the diameter of the passageway 417.

The elongated body 405 may also include a second passage 430 that intersects with the first passage 420. For example, the second passage 430 may extend along a second axis 435 that intersects with the first axis 425. The first passage 420 may terminate within the second passage 430. The first passage 420 and the second passage 430 may be perpendicular to one another (e.g., the first and second axes 425, 435 are substantially perpendicular to one another), although other orientations may be used.

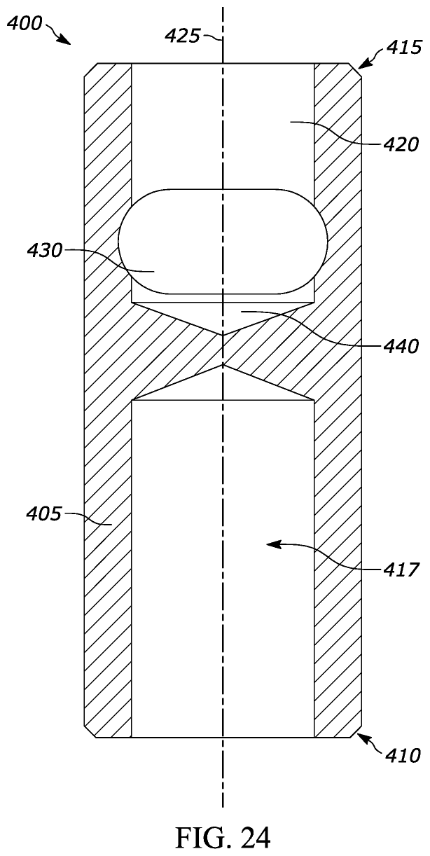

As shown in FIGS. 23 and 24, an opening to the second passage 430 may have an elongated shape. For example, the opening to the second passage 430 may include a substantially elliptical shape. As described in more detail below, the elongated shape may assist in permitting the second passage 430 to accommodate multiple electrical conductors 50.

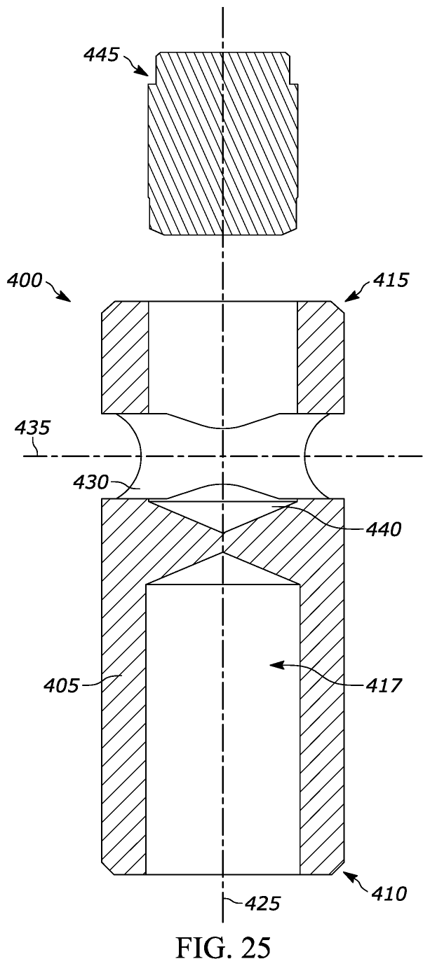

As shown in FIG. 25, the second passage 430 may have a wider diameter at either end and at least slightly narrower diameter toward a center. For example, the second passage 430 may have a constant but narrower diameter moving toward the intersection with the first axis 425. The second passage 430 may increase in width as it intersects with the outer width of the first passage 420 (e.g., before reaching the first axis 425). This width may be larger than the width at either end of the second passage 430.

The rod 400 may also include a depressed region 440 within the second passage 430 that is at least partially aligned with the first axis 425 (e.g., a center of the depressed region 440 may be aligned with the first axis 425). In the illustrated example, the depressed region 440 may be conical in shape with a substantially triangular cross-section, although other shapes may be used (e.g., frustoconical, spherical, elliptical cylindrical, rectangular, etc.).

The pin 445 may be inserted into the first passage 420. The pin 445 may have an at least partially cylindrical shape so that the shape of the pin 445 corresponds to the shape of the first passage 420. For example, an outer diameter of the pin 445 may be substantially similar to an inner diameter of the first passage 420. The pin 445 may fit snuggly within the first passage 420 (e.g., so that there is little to no gap between the pin 445 and the wall of the first passage 420).

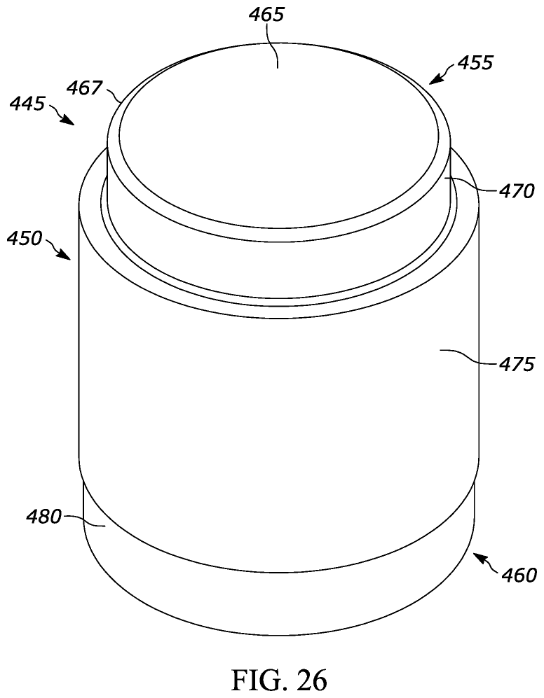

As shown in FIGS. 26 to 28, the pin 445 includes a body 450 having a first end 455 and a second end 460 that is opposite to the first end 455. As described above, the body 450 may have a partially cylindrical shape, although the body 450 may not be a cylinder.

In the illustrated example, the first end 455 of the body 450 includes a substantially flat surface 465. The flat surface 465 includes a circular shape, although other shapes (e.g., elliptical, triangular, rectangular, etc.) may also be used. Additionally, other examples may include a raised surface, which may be formed as a step, a curve, and/or an incline. In certain examples, the surface 465 can be textured, for example having ridges, knurls, or other rough surface textures. The first end 455 may increase in width from the flat surface 465 along an inclined surface 467 and may extend to a substantially cylindrical surface 470. The outer diameter of the cylindrical surface 470 of the first end 455 may be wider than the diameter of the flat surface 465.

A central portion 475 of the body 450 is disposed between the first end 455 and the second end 460. The central portion 475 may be wider than the first end 455. In other words, an outer diameter of the central portion 475 may be wider than the outer diameter of the cylindrical surface 470. The central portion 475 may be substantially cylindrical in shape.

In the illustrated example, the transition between the first end 455 and the central portion 475 may be stepped. In other examples (not shown), the transition may be inclined or curved.

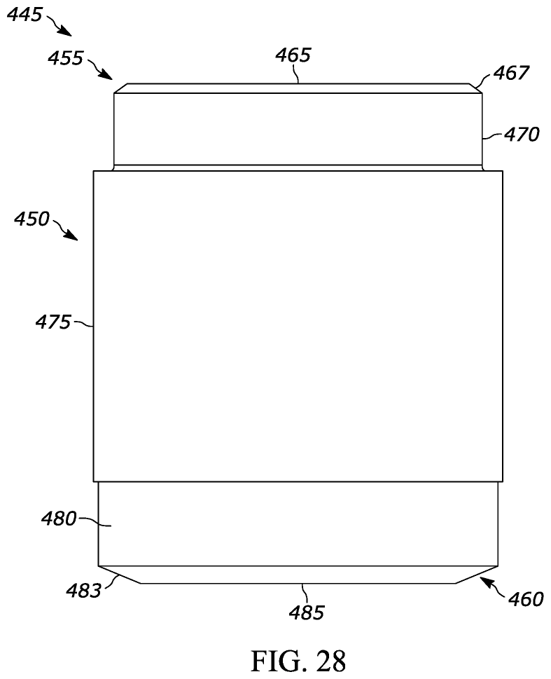

As shown in FIG. 28, the second end 460 of the body 450 may include a similar shape to the first end 455. For example, the second end 460 may include a cylindrical surface 480 proximate to the central portion 475. An inclined surface 483 of the second end 460 extends from the cylindrical surface 480 in a direction away from the central portion 475. A contact surface 485 is disposed at a center of the inclined surface 483.

In the illustrated example, an outer diameter of the cylindrical surface 480 of the second end 460 is smaller than the outer diameter of the central portion 475. The transition between the second end 460 and the central portion 475 may be stepped. In other examples (not shown), the transition may be inclined or curved. In still other examples, there may be no transition between the second end 460 and the central portion 475 (e.g., the second end 460 and the central portion 475 have the same maximum width).

In some forms, the step between the central portion 475 and the second end 460 may be smaller than the step between the central portion 475 and the first end 455. In other words, the outer diameter of the cylindrical surface 480 at the second end 460 may be larger than the outer diameter of the cylindrical surface 470 at the first end 455. The width of the step at the second end 460 is therefore smaller in the radial direction as compared to the width of the step at the first end 455.

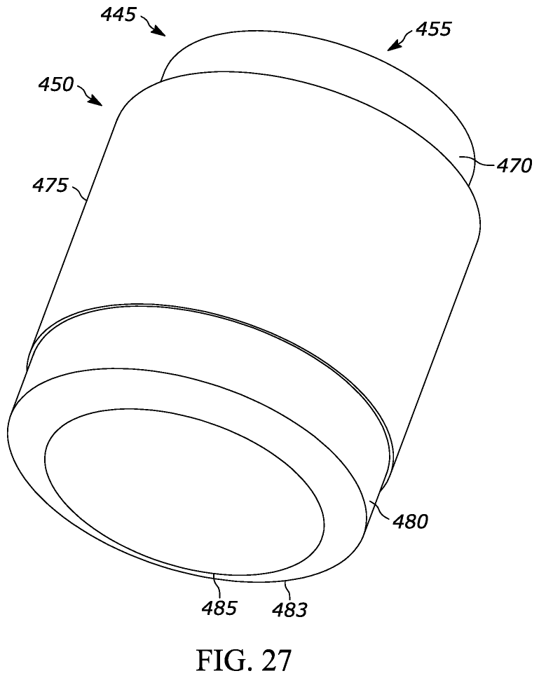

As shown in FIGS. 27 and 28, the contact surface 485 of the second end 460 may be substantially circular in shape, although other shapes may be used (e.g., elliptical, triangular, rectangular, etc.). The contact surface 485 may have a larger diameter than the contact surface 185 of the pin 145. This increase in the size of the contact surface 485 may be to simultaneously contact multiple electrical conductors.

The contact surface 485 may also be approximately equal in surface area to the flat surface 465 (see e.g., FIG. 28), however, other examples may include a contact surface 485 that is smaller or larger than the flat surface 465.

Just as the flat surface 465 provides a sufficient contact area to facilitate providing a force to move the pin within the first passage 420, the contact surface 485 may similarly provide a sufficient contact area to contact across the electrical conductors 50. The surface area of the contact surface 485 may be smaller in order to avoid contact with the wall of the first passage 420 but may otherwise be similar in shape and/or size to the flat surface 465.

As shown in FIGS. 27 and 28, the contact surface 485 may be a blunt surface, which may be substantially flat or planar. For example, the contact surface 485 and the flat surface 465 may be parallel to one another. Additionally, the plane of the contact surface 485 may intersect an edge of the inclined surface 483 of the second end 460. In certain examples, the surface 165 can be textured, for example having ridges, knurls, or other rough surface textures.

In some forms, the contact surface 485 may have a width (e.g., a diameter) that is larger than a combined diameter of the adjacent electrical conductors 50. When centered with the electrical conductors 50, the larger width of the contact surface 485 may allow the pin 445 to contact and compress substantially all the electrical conductors 50.

This improves on a pin with the conical shape that narrows to a point because the contact area of the contact surface 485 is larger. This larger surface area distributes the stresses over a larger area along the electrical conductor so that more of the strands experience the force and high concentrations of stress between strands is reduced or eliminated.

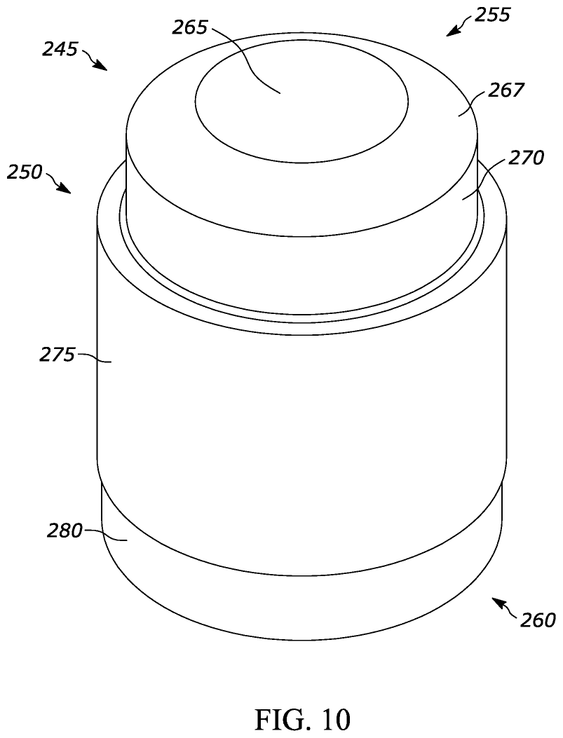

Although not illustrated, pin 245 (e.g., illustrated in FIGS. 10 to 12) and pin 345 (e.g., illustrated in FIGS. 13 to 17) may be manufactured at a larger size to be used with multiple electrical conductors 50. For example, the surface area of the contact surface 285 and the perimeter formed by the edge 397 may be larger to contact multiple electrical conductors 50 when used with the rod 400.

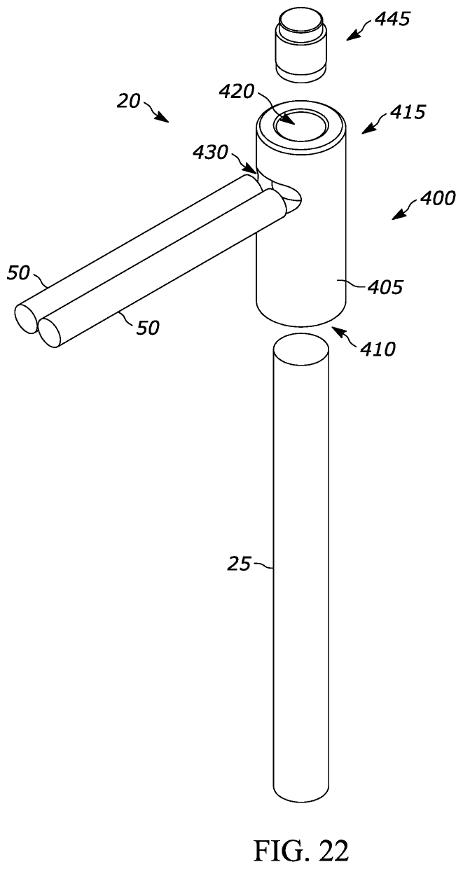

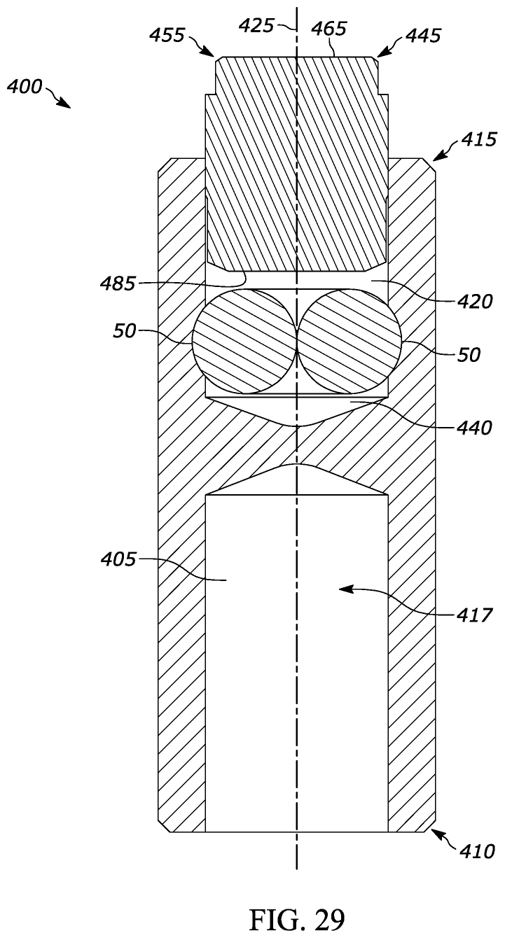

In use, electrical conductors 50 may be inserted into the second passage 430 along the second axis 435 (see e.g., FIGS. 22 and 29). The width of the second passage 430 may be larger than the width of a single electrical conductor 50 and may be similar to the width of two (or more) electrical conductors 50 so that the electrical conductors 50 are able to move along the second passage 430 without moving substantially in the direction of the first axis 425. The entrance to the second passage 430 may be slightly wider of the combined with to facilitate easier insertion of additional conductors 50. In some examples, each electrical conductor 50 may pass entirely through the second passage 430.

As shown in FIG. 29, the second end 460 of the pin 445 may be inserted into the first passage 420 so that the first end 455 remains outside of the first passage 420. As described above, the shape of the central portion 470 may be substantially similar to the shape of the first passage 420. Thus, the pin 445 may not be able to substantially move along the direction of the second axis 435.

In some forms, the pin 445 and the rod 400 may be partially assembled prior to use (e.g., partially assembled when shipped to the user). The pin 445 may be positioned so that the cylindrical surface 480 is positioned within the first passage 420. Because the cylindrical surface 480 has an outer diameter that is less than the diameter of the first passage 420, the pin may not be pre-secured to the rod 400. Thus, the smaller diameter of the cylindrical surface 480 assists in guiding the pin 445 into the first passage 420 without pre-securing the pin 445.

In some forms, the width of the first passage 420 may not allow the pin 445 to freely slide along the first axis 425. An outside force may be applied in order to move the pin 445 along the first axis 425. For example, a hammer or other tool may be used to apply a force to the flat surface 465 to move the pin 445. The flat surface 465 provides an even surface to apply a force in order to limit the travel of the pin 445 in a direction other than along the first axis 425.

In some forms, the increased width of the central portion 475 compared to the first end 455 may provide a visual indicator for the user. For example, the first end 455 may remain substantially outside of the first passage 420 to avoid over-compressing the conductor. The difference in width may alert the user before the pin 445 over-travels within the first passage 420.

As shown in FIG. 29, the contact surface 485 may have a width that is approximately equal to the second passage 430. The width of the electrical conductors 50 may not exceed the width of the second passage 430, so the width of the contact surface 485 may always be equal to or greater than the combined width of the electrical conductor 50. This may limit instances where the contact surface 485 applies a force onto each electrical conductor 50 in a small area where strand splitting could occur. In other examples, the width of the contact surface 485 may be less than the width of the second passage 430. In these situations, the contact surface 485 may remain sufficiently large in order to contact multiple strands of the electrical conductors 50 (or electrical conductors 50 with single stands).

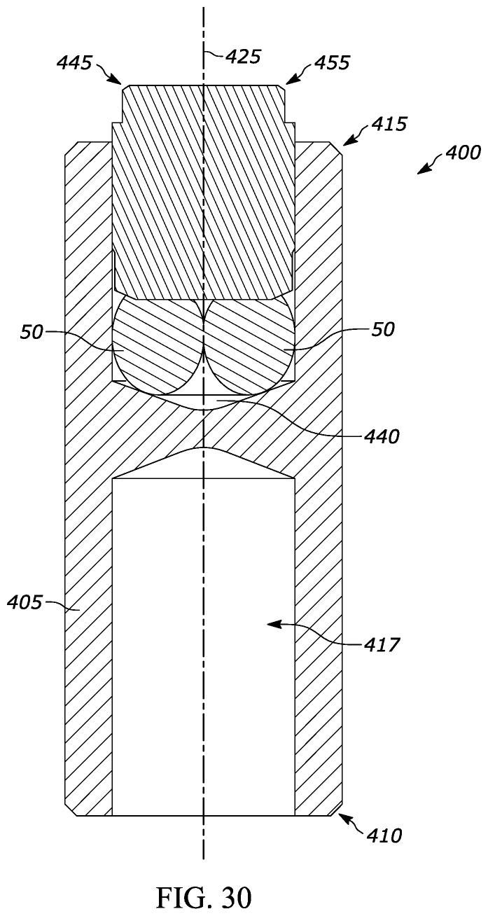

As shown in FIG. 30, the pin 445 eventually contacts the electrical conductors 50 as the pin 445 moves along the first axis 425 (e.g., because of a force applied to the flat surface 465). Specifically, the contact surface 485 meets the electrical conductors 50 proximate to an entrance of the second passage 430 from the first passage 420. The substantially flat surface of the contact surface 485 may provide a substantially even surface for contacting the electrical conductors 50. This contact may be along the first axis 425 (e.g., in an inferior direction as viewed in FIG. 30) against a perpendicular plane that is tangent to or coplanar with a surface of the electrical conductor 50. This plane may intersect the electrical conductors 50 so that it intersects with multiple strands of the electrical conductor 50 or is parallel to a plane that intersects multiple strands of the electrical conductor 50. As additional force is provided to the pin 445, the contact surface 485 may begin to compress the electrical conductors 50. The compression may be distributed across the surface of the electrical conductors 50 in contact with the contact surface 485. As shown between FIGS. 29 to 30, continued force applied to the pin 445 may move the plane where contact (and therefore compression) occurs toward the first end 410. This plane may remain substantially parallel to the second axis 435.

This compression between the pin 445 and the surface of the second passage 430 may limit movement of the electrical conductors 50 with respect to the second passage 430. Additionally, the electrical conductors 50 may compress into the depressed region 440, which may further limit movement of the electrical conductors 50 along the second passage 430.

In some forms, the electrical conductors 50 may both be multiple strand electrical conductors, may both be single strand electrical conductors, or one electrical conductor 50 may have multiple strands and one may have a single strand.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the invention may be practiced other than as specifically described.

1. A mechanical connector for securing an electrical conductor, the mechanical connector comprising:
a rod comprising:
a rod body with a first rod end and a second rod end opposite to the first rod end,
a first passage extending at least partially through the body, and
a second passage extending at least partially through the body and intersecting with the first passage, wherein the second passage includes an opening with a second passage width that is configured to receive the electrical conductor; and
a pin configured to be inserted through the first passage and toward the second passage, the pin comprising:
a pin body with a first pin end and a second pin end opposite to the first pin end,
wherein the second pin end includes a blunt contact surface that is configured to contact the electrical conductor within the second passage.

2. The mechanical connector of claim 1, wherein:
the first passage is disposed at the first rod end and extends partially through the rod body along a first axis until it reaches the second passage;
the second passage is disposed proximate to the first rod end and extends entirely through the rod body along a second axis; and
the first axis and the second axis are substantially perpendicular with respect to one another.

3. The mechanical connector of claim 1, wherein the first pin end includes a substantially flat surface configured to remain outside of the first passage and receive an applied force to move the second pin end toward the second passage.

4. The mechanical connector of claim 1, wherein the pin body further comprises a central portion disposed between the first pin end and the second pin end, the central portion has an outer diameter that is larger than an outer diameter of both the first pin end and the second pin end, and wherein the outer diameter of the central portion is substantially the same as an inner diameter of the first passage.

5. The mechanical connector of claim 1, wherein a width of the contact surface is approximately equal to the second passage width.

6. The mechanical connector of claim 1, wherein the second pin end is formed as a frustoconical shape with an inclined surface that forms an edge of the contact surface.

7. The mechanical connector of claim 1, wherein second pin end is formed as a frustoconical shape, and wherein the contact surface is formed at an end of a protruding section that extends away from the frustoconical shape.

8. A pin for use securing an electrical conductor within a passage, the pin comprising:
a first end including a first surface configured to receive an external force;
a second end disposed opposite to the first end, wherein the second end includes a frustoconical shaped region and a second surface disposed at an end of the frustoconical shaped region;
a central portion disposed between the first end and the second end, the central portion having a greater width than either the first end or the second end;
wherein the second end is configured to be positioned within the passage and extend across an associated electrical conductor.

9. The pin of claim 8, wherein a transition between the first end and the central portion is stepped and/or wherein a transition between the second end and the central portion is stepped.

10. The pin of claim 8, wherein the first surface is parallel to the second surface.

11. The pin of claim 8, wherein the frustoconical shaped region includes an inclined surface that decreases in diameter in a direction away from the central portion, and wherein an edge of the inclined surface forms an outer perimeter of the second surface.

12. The pin of claim 8, wherein a protruding section extends outwardly from the frustoconical shaped region in a direction away from the first end, and wherein the second surface is formed at an end of the protruding section.

13. The pin of claim 12, wherein the protruding section is substantially cylindrical in shape.

14. The pin of claim 8, wherein a surface area of the second end is at least 50% of the surface area of the first end.

15. The pin of claim 8, wherein the second surface is conical or frustoconical in shape that forms a cavity with a width that decreases in a direction toward the first end, and wherein an edge surrounding the second surface is configured to contact the electrical conductor.

16. The pin of claim 15, wherein an entrance to the cavity is substantially planer with an end of the frustoconical shaped region.

17. The pin of claim 15, wherein the width of the first surface is greater than a largest width of the cavity.

18. A method of securing an electrical conductor, the method comprising:
positioning a pin partially within a first passage of a rod;
positioning the electrical conductor within a second passage of the rod, wherein the first passage and the second passage are substantially perpendicular to one another;
applying a force to a first end of the pin at least partially exposed from the first passage;
moving a second end of the pin into contact with the electrical conductor, wherein the second end includes a planar contact surface configured to engage the electrical conductor against a first plane parallel to the second passage; and
compressing the electrical conductor against a surface of the second passage, wherein the planar contact surface is configured to engage the electrical conductor against a second plane parallel to the first plane.

19. The method of claim 18, wherein the planar contact surface is configured to distribute a force across a surface of the electrical conductor contained on the parallel plane.

20. The method of claim 18, wherein the electrical conductor has at least two strands, wherein the planar contact surface is configured to engage the at least two strands.

21.-41. (canceled)
